(19) United States
(12) Patent Application Publication
(10) Pub. No.: US 2025/0311672 A1
(43) Pub. Date: Oct. 9, 2025

(54) Communication System Between Grain Handling Equipment and Grain Mixing System and Method of Use Thereof to Achieve Target Grain Parameter

(71) Applicant: ELMER'S WELDING & MANUFACTURING LTD., Altona (CA)

(72) Inventors: Rheal M. Boileau, Altona (CA); Owen S. Darrach, Altona (CA); Michael I.J. Friesen, Altona (CA); Matthew P. Froese, Altona (CA)

(21) Appl. No.: 19/092,441

(22) Filed: Mar. 27, 2025

Related U.S. Application Data
(60) Provisional application No. 63/574,368, filed on Apr. 4, 2024.

(51) Int. Cl. A01D 41/127; A01D 41/12

(52) U.S. Cl. CPC A01D 41/1277; A01D 41/1208

(57) ABSTRACT

A grain mixing system for a storage apparatus has variable discharges associated with respective grain storage regions of the apparatus. A computer controller stores (i) target grain parameters representing a desired parameter value of the grain at a common outlet of the apparatus, and (ii) regional grain parameters associated with each grain storage region representative of a parameter value of the grain stored in that grain storage region. The controller controls operation of the variable discharges so as to combine the grain from the different grain storage regions at the common outlet in controllably variable proportions to achieve the target grain parameter at the common outlet based at least in part on the regional grain parameters as inputs to the controller. This system can be used to blend grain from regions with different parameters to achieve an overall target parameter, such as a target moisture content and/or protein level.

This application claims the benefit under 35 U.S.C.119(e) of U.S. provisional application Ser. No. 63/574,368, filed Apr. 4, 2024.

### FIELD OF THE INVENTION

The present invention relates to a grain mixing system arranged to blend stored grain from different sources and having different grain properties associated therewith to achieve a blended output having a targeted grain property. Furthermore, the present invention relates to a communication system for communicating grain parameter data relating to properties of the grain between various grain handling equipment for use by the grain mixing system to achieve the targeted grain property.

### BACKGROUND

Current grain handling equipment used during harvest (such as grain carts and field bins) have little control of the properties of the grain they output or unload. Current equipment can be categorized into one of 2 groups based on their unloading ability: one-dimensional unloading or two-dimensional unloading.

In one-dimensional unloading, the equipment outputs or unloads grain or material based on a binary system (unloading active or unloading inactive), or a variable system (variable between 0% unloading and 100% unloading, either incrementally or infinitely). With these systems, although varying unloading rate may be possible, the order in which the material in the equipment's storage container is unloaded is entirely subject to the original distribution of material in the container, the mechanical characteristics of the equipment, and the flow characteristics of the material. Examples of this group of equipment are combine harvesters, grain trucks/trailers, and grain carts.

In two-dimensional unloading, the equipment adds to the capability of one-dimensional unloading with the ability to select, between 2 or more areas or compartments of the equipment's material container, a fixed proportion of material that is being unloaded. For example, a piece of equipment that has 2 compartments could select to unload 25% from the front compartment and 75% from the rear compartment. While this equipment has the ability to blend 2 volumes of material by varying the relative unload proportions, current systems lack the input data and control system to blend material with any valuable output.

### SUMMARY OF THE INVENTION

According to one aspect of the invention there is provided a grain mixing system comprising:
a grain storage apparatus arranged to receive grain to be stored therein;
a plurality of variable discharges operatively connected to the grain storage apparatus, in which each variable discharge is arranged to discharge the grain from an associated grain storage region of the grain storage apparatus at a respective variable discharge rate to a common outlet of the grain storage apparatus;
a controller operatively connected to the variable discharges, the controller including a processor and a memory storing (i) programming instructions, (ii) a target grain parameter representing a desired parameter value of the grain at the common outlet, and (iii) a regional grain parameter associated with each grain storage region in which the regional grain parameter is representative of a parameter value of the grain stored in that grain storage region;
wherein the processor of the controller is arranged to execute the programming instructions whereby the controller is arranged to control operation of the variable discharges so as to combine the grain from the different grain storage regions at the common outlet in controllably variable proportions to achieve the target grain parameter at the common outlet based at least in part on the regional grain parameters as inputs to the controller.

The modern farmer is always searching to improve the efficiency of their operation, and to maximize the return on their yearly investment. Agricultural equipment manufacturers must in turn develop new innovative solutions to meet the increasing demands of their customers. The present invention increases the efficiency of the harvesting operation by allowing a crop to be harvested sooner, and achieves a higher average sell price for an operation's marketed grain. More particularly, the proposed design builds on existing two-dimensional unloading by integrating data from a combination of live onboard sensor readings, data maps from loads input into the equipment, and an unload target. For example, a target moisture content can be set for an unload. The equipment may or may not estimate a starting relative unload proportion from each of its areas or compartments based on data received from each of the material loads input into the equipment, including where the load was input, when the load was input, and/or the moisture content of that load. From there, the system continually adjusts the relative unload proportions using: (i) data from various onboard sensors measuring the moisture content or protein level of the material being unloaded, (ii) data from sensors measuring the volume or weight of material in each of the areas or compartments, and/or (iii) data maps from the loads input into the equipment in order to achieve the target parameter.

This system can be used to hit targets of moisture content and/or protein level in addition to multiple other benefits to the user. Where a field has an area of higher moisture crop, a farmer would traditionally have to wait to harvest the entire field until the area has dried down, harvest around the area to return to it once it has dried down, or harvest the high moisture crop at the risk of storage issues (mold or combustion). With this system, the high moisture crop harvested can be blended with low moisture crop harvested from other areas of the field, allowing the farmer to harvest earlier without the risks of storing crops at high moisture. Additionally, the farmer may secure a higher average selling price for their grain by distributing this high moisture grain. The same can be said for protein level in crops, where the ability to blend high and low protein crop may achieve a higher average selling price, earning the farmer a higher return.

This system could see further efficiency by directing material input into the equipment to specific areas or compartments based on the known properties of the material. For example, the equipment could have designated high moisture compartments (material above the target moisture content) and low moisture compartments (material below the target moisture content). The input of material can be directed to the appropriate compartment, which makes the blending process more efficient. The same can be said for high/low protein levels.

As described herein, one aspect of the present invention relates to a system for controlling the unloading of grain or material where: (i) an unload target parameter is set (moisture level or protein level), (ii) the system adjusts the relative unload proportions between 2 or more areas or compartments of the equipment's holding tank based on live sensor readings of current unload parameters (moisture and/or protein), and/or current material levels, (iii) stored data maps of grain/material parameters by location in equipment's holding tank can be obtained through sensors onboard harvesting equipment or onboard intermediary handling equipment such as a grain cart, and/or (iv) the unload target is set by the user.

Preferably the target grain parameter and the regional grain parameters relate to at least one of moisture content, protein level, oil content, or density of the grain.

Preferably the controller stores more than one different parameter type for each of the target grain parameter and the regional grain parameter. In this instance, the controller may be further arranged to set which parameter type is selected as the target grain parameter in response to a user selection.

The grain storage regions may comprise respective compartments of the grain storage apparatus which are separated from one another by at least one barrier.

The system may further include a load opening associated with each grain storage region of the grain storage apparatus such that the grain storage regions are arranged to be loaded with grain independently of one another.

Preferably the target grain parameter is programmably adjustable by the controller in response to a user input.

The system preferably includes an output parameter sensor arranged to measure an output grain parameter at the common outlet of the grain storage apparatus for communication to the controller.

The controller may be arranged to controllably vary the discharge rate of each variable discharge in real time in response to deviation of the output grain parameter from the target grain parameter.

The system may further include at least one regional parameter sensor associated with each grain storage region, in which the controller is arranged to acquire the regional grain parameters from the parameter sensors associated with the grain storage regions respectively.

When a plurality of regional parameter sensors associated with each grain storage region, the controller is preferably arranged to acquire a plurality of measured values relating to the regional grain parameter for each grain storage region.

When the system is further arranged for use with a grain transport apparatus for unloading grain from the grain transport apparatus into the grain storage apparatus, the system may further comprise a communication device operatively connected to the controller, in which the communication device is arranged to communicate with the grain transport apparatus so as to acquire the regional grain parameters from the grain transport apparatus.

The regional grain parameter for each grain storage region may comprise a parameter map of a plurality of different parameter values associated with the grain stored at respective different portions of the grain storage region. Preferably each parameter value of each parameter map is derived from a respective grain load which has been loaded into the grain storage apparatus from a grain transport apparatus. Furthermore, each parameter value derived from a respective grain load may be an average value that is representative of a plurality of measured values associated with respective loading events of the grain transport apparatus.

When the system is arranged for use with a grain transport apparatus for unloading grain from the grain transport apparatus into the grain storage apparatus, the controller may be further arranged to: (i) determine an optimal region among the different grain storage regions to discharge the grain from the grain transport apparatus based at least in part on said at least one of the target grain parameter, the transported grain parameter, and the regional grain parameters; and (ii) communicate the optimal region to an operator of the grain transport apparatus.

According to a second aspect of the present invention there is provided a control system for unloading grain from (i) a grain transport apparatus having transported grain therein with a transported grain parameter associated with the transported grain to (ii) a grain storage apparatus arranged to blend stored grain from different grain storage regions of the grain storage apparatus having respective regional grain parameters associated with the different grain storage regions to achieve a target grain parameter at a common outlet of the grain storage apparatus, the control system comprising:
a controller; and
a communication device operatively connected to the controller so as to be arranged to communicate at least one of the target grain parameter, the transported grain parameter, and the regional grain parameters to the controller;
the controller including a processor and a memory storing programming instructions arranged to be executed by the processor whereby the controller is arranged to:
   (i) determine an optimal region among the different grain storage regions to discharge the grain from the grain transport apparatus based at least in part on said at least one of the target grain parameter, the transported grain parameter, and the regional grain parameters; and
   (ii) communicate the optimal region to an operator of the grain transport apparatus.

Preferably the target grain parameter, the transported grain parameter, and the regional grain parameters relate to at least one of moisture content, protein level, oil content, or density of the grain.

In this instance, the present invention provides a communication system for a temporary grain storage device (field bin) and grain transportation device (grain cart) where: (i) a target unload parameter (moisture/protein) from the grain storage device is set; (ii) grain parameters in the grain transportation device are known, either through sensors onboard harvesting equipment or onboard the grain transportation device, and (iii) the desired unload location of the grain transportation device into the grain storage device, based on the properties of the grain in the grain transportation device and the blending strategy of the grain storage device, is communicated to the grain transport device or operator.

According to a further aspect of the present invention there is provided a method of unloading grain from (i) a grain transport apparatus having transported grain therein with a transported grain parameter associated with the transported grain to (ii) a grain storage apparatus arranged to blend stored grain from different grain storage regions of the grain storage apparatus having respective regional grain parameters associated with the different grain storage regions to achieve a target grain parameter at a common outlet of the grain storage apparatus, the method comprising:
determining an optimal region among the different grain storage regions to discharge the grain from the grain transport apparatus based at least in part on at least one of the target grain parameter, the transported grain parameter, and the regional grain parameters; and
communicating the optimal region to an operator of the grain transport apparatus.

Preferably the method further includes unloading the transported grain from the grain transport apparatus into the determined optimal region of the grain transport apparatus in response to a communication to the operator relating to the determined optimal region.

### BRIEF DESCRIPTION OF THE DRAWINGS

Some embodiments of the invention will now be described in conjunction with the accompanying drawings in which:

FIG. 1 is a schematic representation of the grain mixing system and the control system for communicating grain parameter data between various grain handling equipment for use by the grain mixing system according to the present invention;

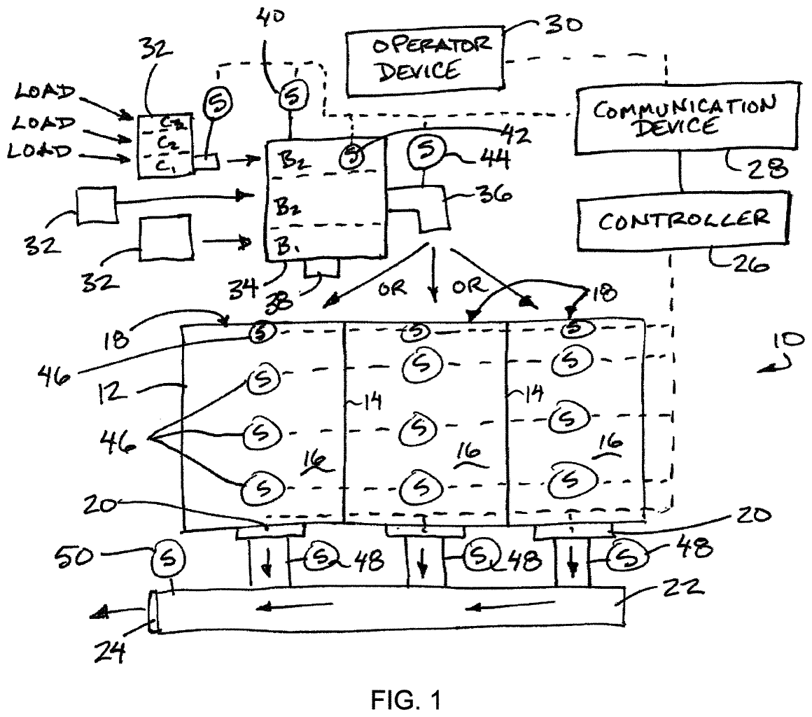

FIG. 2 is a flow chart representing operation of the grain mixing system;

FIG. 3 is a schematic representation of the grain storage apparatus of the grain mixing system according to the present invention; and

FIG. 4 is a schematic representation of the flow of grain parameter data between various grain handling equipment for use by the grain mixing system according to the present invention.

In the drawings like characters of reference indicate corresponding parts in the different figures.

### DETAILED DESCRIPTION

Referring to the accompanying figures there is illustrated a grain mixing system generally indicated by reference numeral 10. The grain mixing system 10 is particularly suited for blending grain from different sources having different properties or parameters associated therewith, for example moisture content, protein level, oil content, density and the like, to achieve a blended output grain having a targeted property or parameter selected by the operator.

The grain mixing system 10 includes a grain storage apparatus 12 in the form of a large vessel or container for storing grain therein in which one or more interior barrier walls 14 separates the interior storage volume of the apparatus 12 into a plurality of separate compartments in which each separate compartment defines a respective grain storage region 16 storing a respective portion of the stored grain therein. In further embodiments however, the grain storage regions 16 may not be physically separated from one another but may merely represent different areas within a common storage envelope which discharge to different respective discharge openings of the apparatus.

In the illustrated embodiment, the compartments are aligned in a horizontal and longitudinally extending row. Each grain storage region 16 has an open top 18 or a respective inlet opening associated therewith permitting that grain storage region 16 to be loaded with grain independently of the other regions.

Each grain storage region 16 of the grain storage apparatus 12 also includes a variable discharge 20 associated therewith. In this instance, the bottom of each grain storage region 16 may comprise a hopper wall which is sloped downwardly towards a discharge opening selectively enclosed by a horizontal slide gate. The gate can be displaced through a range of positions between a fully open position and a fully closed position so as to vary the cross-sectional size of the discharge opening through which grain can be discharged which in turn varies the discharge rate from the respective grain storage region associated with that variable discharge 20. A suitable actuator is used to control the position of the gate.

In the illustrated embodiment, a common discharge conveyor 22 is associated with all of the variable discharges 20 of the grain storage regions 16 to direct all discharged grain to a common outlet 24 of the grain storage apparatus 12. Each of the variable discharges 20 is arranged to discharge grain into the common discharge conveyor 22 which mixes the grain while transporting the grain to the common outlet 24.

A controller 26 of the grain storage apparatus generates the appropriate signals for controlling the opening and closing or varying position of the gates of the variable discharges 20 such that the controller is arranged to control operation of the variable discharges to combine grain from the different grain storage regions at the common outlet in controllably variable proportions to achieve target parameters at the common outlet based at least in part on grain parameters associated with the grain within the different grain storage regions being used as inputs to the controller. The controller is a computer device having a processor and a memory storing programming instructions thereon that are arranged to be executed by the processor so as to perform the various functions of the controller described herein.

A communication device 28 is operatively connected to the controller 26 for communicating various data to and from the controller. This includes collecting data from a plurality of sensors distributed throughout the grain mixing system 10 which sense various grain parameters and communicates the measured values to the controller for storing values and using the values as inputs in controlling the proportional discharge of the variable discharges 20. The communication device 28 may also be arranged to communicate with other equipment to acquire parameter data relating to grain properties of grain that is unloaded into the grain storage apparatus 12 from a variety of sources. The communication device 28 is further arranged for communicating with other grain handling equipment as well as communicating with a computer device 30 associated with the operator of the grain mixing system or an operator of other grain handling equipment used in conjunction with the grain mixing system as described in further detail below.

Some of the grain handling equipment with which the grain storage apparatus may be used includes (i) a first grain transport apparatus 32 for example a grain cart that receives grain loaded therein in a plurality of separate loading events from a combine harvester 33 and which is capable of discharging directly into the grain storage apparatus 12 or other grain handling equipment, and (ii) a second grain transport apparatus 34 in the form of a mobile field bin that can receive multiple grain cart loads of grain therein prior to delivery and discharge of the grain into the grain storage apparatus 12.

In each instance, the first grain transport apparatus 32 or the second grain transport apparatus 34 generally comprises a portable grain storage vessel supported on wheels for transport across the ground when towed by an agricultural tractor. The grain transport apparatus includes a storage container thereon having an inlet at a top end permitting grain to be loaded into the container and an outlet. Similarly to the combine harvesters 33, each outlet typically comprises a transfer conveyor 36 for unloading grain from the storage container of the combine harvester or grain transport apparatus into downstream grain handling equipment. In the instance, of the grain transport apparatus, the transfer conveyor 36 is powered by the agricultural tractor.

In some instances, the grain mixing system 10 is operated by using the first grain transport apparatus 32 to collect grain from one or more combine harvesters 33 in a plurality of separate loading events followed by discharging the first grain transport apparatus into the second grain transport apparatus which is capable of receiving multiple grain cart loads therein prior to discharging all of the contents of the second grain transport apparatus 34 into the grain storage apparatus 12. Alternatively, the second grain transport apparatus 34 may be omitted by loading each full load of the first grain transport apparatus 32 directly into the grain storage apparatus.

Each of the combine harvesters 33 and grain transport apparatuses 32 or 34 includes its own transport controller 38 which (i) collects grain parameter data with regard to various grain parameters associated with the grain with each loading of grain into the transport apparatus either from upstream equipment or from onboard sensors of the grain transport apparatus, (ii) stores and/or processes the grain parameter data, and (iii) transmits the collected grain parameter data to downstream equipment in the communication chain. In the instance where multiple loading events resulted in the loading of the container of the grain transport apparatus, the controller may be arranged to store parameter values associated with each individual loading event as a map of multiple parameter values associated with grain stored in resultant regions within the grain storage container derived from the loading order. Alternatively, the transport controller 38 may be arranged to average the parameters values received with different loading events and output an overall average value to downstream equipment that represents the entirety of the grain being unloaded.

In preferred arrangements, the combine harvesters and the grain transport apparatuses 32 or 34 include one or more sensors thereon at one or more locations for measuring various grain properties and recording the measured parameter values. In some instances, the sensors may comprise input sensors 40 that measure characteristics of the grain being loaded into the grain storage apparatus. The apparatus may also include one or more container sensors 42 supported at one location or at distributed locations within the grain storage volume of the storage container for generating a map of the varying parameters of the grain within the storage container. Each apparatus may also include one or more output sensors 44 at the transfer conveyor 36 for sensing characteristics of the grain being transferred by the transfer conveyor 36 out of the storage container and into downstream grain handling equipment.

The controller 38 of each grain storage apparatus is capable of generating parameter maps by sensing or acquiring from upstream equipment parameter values associated with the grain loaded into the container of the grain transport apparatus 32 or 34 as well as recording the volume or weight of grain associated with each loading event. The controller 38 thus generates a map of the overall storage volume separated into regions representing the volume or mass of each load within the container as well as one or more parameter values associated with each region. The grain transport apparatus may transfer the entire map or may use the map to calculate average parameter values associated with the stored grain that is subsequently unloaded with each unload event of the grain transport apparatus into the next downstream equipment. Each grain transport apparatus communicates parameter values and is able to identify which portion of the stored grain is associated with those values so that the identification of the grain with that associated parameter value can also be transmitted to the downstream equipment.

The storage controller 26 of the grain storage apparatus 12 can use all of the collected parameter values from upstream equipment including combines and intermediate grain transport apparatuses in evaluating the parameters of the grain stored within the grain storage apparatus. The storage controller 26 of the grain storage apparatus 12 can rely entirely on parameter data from upstream equipment in identifying parameter values for the stored grain within each grain storage region 16 of the grain storage apparatus, or may include additional sensors for measuring grain characteristics to generate parameter values.

Sensors on the grain storage apparatus can include one or more regional sensors 46 within each grain storage region for directly measuring grain characteristics to determine parameter values for the grain within each region. When multiple regional sensors are provided within each grain storage region 16, the sensors may be arranged in an array, for example by locating the sensors at different elevations such that the regional sensors 46 can generate a suitable map identifying differing parameter values for different layers or portions of grain within each grain storage region 16. Alternatively, the parameter map for each grain storage region can be generated as described above with regards to the grain transport apparatuses by tracking the volume or weight of grain loaded into each grain storage region for each load and assigning parameter values associated with that load of grain based on data acquired from the upstream grain handling equipment.

The sensors of the grain storage apparatus can also include a discharge sensor 48 associated with each variable discharge 20 for measuring one or more characteristics associated with the grain being discharged as a continuous stream of measured values that are measured in real time as the grain is discharged. The parameter values measured at each variable discharge by the discharge sensors 48 can be used as the regional grain parameters associated with the grain storage regions respectively as inputs into the controller.

An outlet sensor 50 can be provided at the common outlet of the grain storage apparatus to validate that a desired target grain parameter has been achieved by the blended proportions prescribed by the controller. The outlet sensor 50 thus measures an output grain parameter associated with the blended and mixed grain output from the grain storage apparatus.

The storage controller 26 of the grain storage apparatus 12 is arranged to receive all parameter data from upstream equipment and/or various onboard sensors to generate a map of the contents of the grain storage apparatus. The controller also tracks the weight or volume of material unloaded from each grain storage region in addition to tracking the amount of material loaded into individual grain storage regions by various upstream equipment at each loading event to continuously update the parameter map which records parameter values for the respective portions of grain within each grain storage region as the grain storage regions are loaded from the top and discharged from the bottom at prescribed rates. Suitable flow rate sensors may be associated with each variable discharge for monitoring the amount of material discharged from the grain storage regions, or the amount of material discharged can be inferred from the operational state of the variable discharge 20 for each region.

To achieve a desired output property at the common outlet of the grain storage apparatus, the storage controller 26 of the grain storage apparatus follows a prescribed blending strategy dictated by the programming instructions and various user selections which are input into the controller. User inputs include a target grain parameter representing a desired value or range of values of a prescribed grain characteristic. When the system tracks a plurality of different grain characteristics such as moisture content, protein level, oil content, density and the like, the target grain parameter may also involve a selection by the user with regards to the type of grain characteristic or grain parameter being targeted.

Using the input by the operator relating to the parameter type and the target value of the collected target grain parameter, as well as the parameter map relating to the characteristics or properties of the grain distributed within the grain storage regions 16, the controller determines the required proportions from the different grain storage regions that must be discharged and mixed together to produce an average value output at the common outlet 24 that meets the target grain parameter and then generates the appropriate actuator signals to position the variable discharges at the required position to achieve the determined proportions.

The outlet sensor 50 can be used to validate that the target grain parameter has been met. In the event of deviation of the output grain parameter as measured by the outlet sensor 50 from the targeted range prescribed by the target grain parameter input by the user, the controller will generate corrective signals to the actuators of the variable discharges 20 to vary the proportions to return the measured output grain parameters at the common outlet 24 to a measured value that is within the prescribed range dictated by the selected target grain parameter. The controller may continue to operate in this manner by measuring or sensing grain characteristics of the grain being discharged in real time while continuously generating new command signals for the variable discharges to adjust the proportions being discharged between the different regions. The controller also updates the parameter maps of the contents of the grain storage regions in real time as material is discharged so that the controller can optimally predict the approximate parameter values of the grain being actively discharged by each variable discharge at all times.

In some instances, the controller will be assigned threshold ranges for selected properties for each of the grain storage regions 16. For example, one region may be designated as a low moisture region in which grain therein has a moisture content below a lower threshold, one region may be designated as a medium moisture region in which the grain therein has a moisture content between the lower threshold and an upper threshold, and one region may be designated as a high moisture region in which grain therein has a moisture content above the upper threshold. Any loads of grain in which the average parameter value associated with that load fits within the prescribed range for one of the grain storage regions will result in the controller communicating to the operator of the transfer equipment which grain storage region 16 the new load of grain should be discharged into to maintain the properties of the grain within the different regions within their respective prescribed ranges. In some instances, if the levels in the different regions 16 are uneven, the controller may adjust the thresholds to result in a more even distribution of grain among the different regions.

For each new load of grain to be unloaded into the grain storage apparatus, the storage controller 26 of the grain storage apparatus can receive various inputs including the prescribed blending strategy dictated by the operator, regional grain parameters which are sensed or acquired and which are associated with the grain within each grain storage region 16, the tracked amount of stored grain within each grain storage region, the target grain parameter dictated by the operator, and the transported grain parameters that define grain characteristics of the grain being transported in the load to be transferred into the grain storage apparatus. Using some or all of these inputs, the controller determines an optimal region among the different grain storage regions where the new load of grain should be discharged into in order to achieve the target grain parameter according to the prescribed blending strategy. Once determined, the optimal region determined by the controller can be transmitted by the communication device 28 to the user computer device 30 of the operator of the equipment. For example a communication can be directed to a tablet computer carried by an operator within the agricultural tractor towing the grain cart to be unloaded so that upon receipt of the communication, the operator then unloads the grain cart into the grain storage region 16 dictated by the communication. In more complex systems, the equipment may be configured to automatically unload into a specific grain storage region upon determination of the optimal region for unloading.

In this regard, the storage controller 26 of the grain storage apparatus 12 and the transport controllers 38 of the various grain transport apparatuses, with their respective communication devices operatively connected thereto, collectively form an overall communication and control system for collecting and sharing parameter data relating to grain characteristics sensed at various locations so that this information can be used by the various controllers to execute the various functions described herein. Accordingly, it may be a controller operating on the grain cart or in the agricultural tractor operating the grain cart which determines an optimal region among the grain storage regions of the grain storage apparatus where the grain cart should be unloaded. The communication of the parameter data relating to measured grain characteristics is automatically transferred between grain handling equipment together with grain loads being transferred so that the grain storage apparatus 12 is best informed to optimally control the variable discharges 20 to achieve the target grain parameter at the common outlet 24.

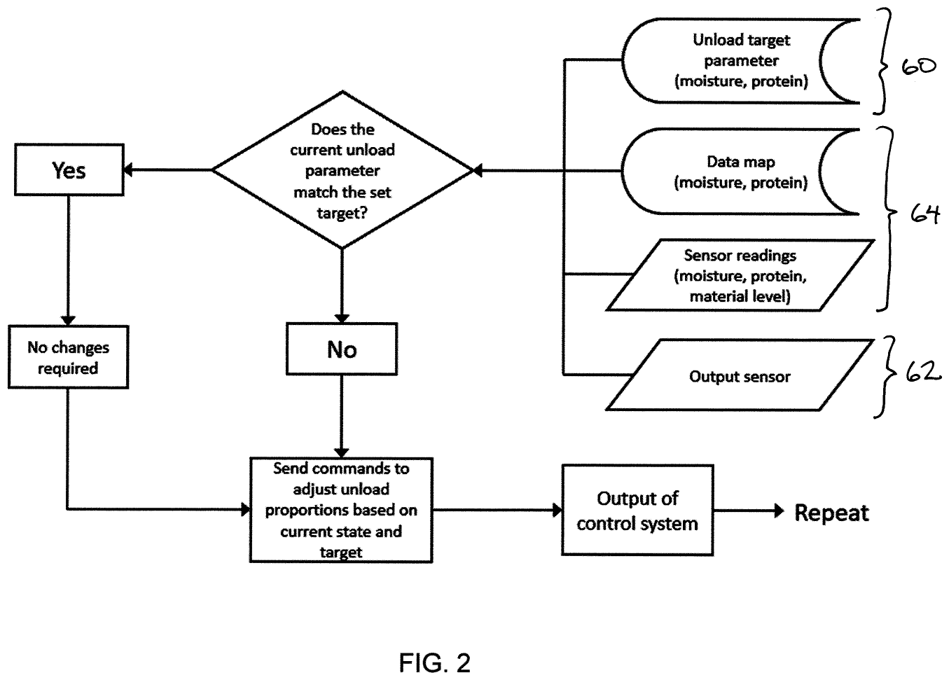

As shown in FIG. 2, the controller acquires the target grain parameter 60 input by the user, the output grain parameter 62 measured at the common outlet 24 and the regional grain parameters 64 measured by various sensors or acquired from upstream equipment to generate a data map. Using these inputs, the controller determines if the current output parameter matches the set target parameter. No change to the operation is required if the target parameter has been met, however, if the target parameter has not been met then the controller sends suitable commands to adjust the unload proportions based on the current state and the desired target. The system continues to operate in this manner to achieve the desired output.

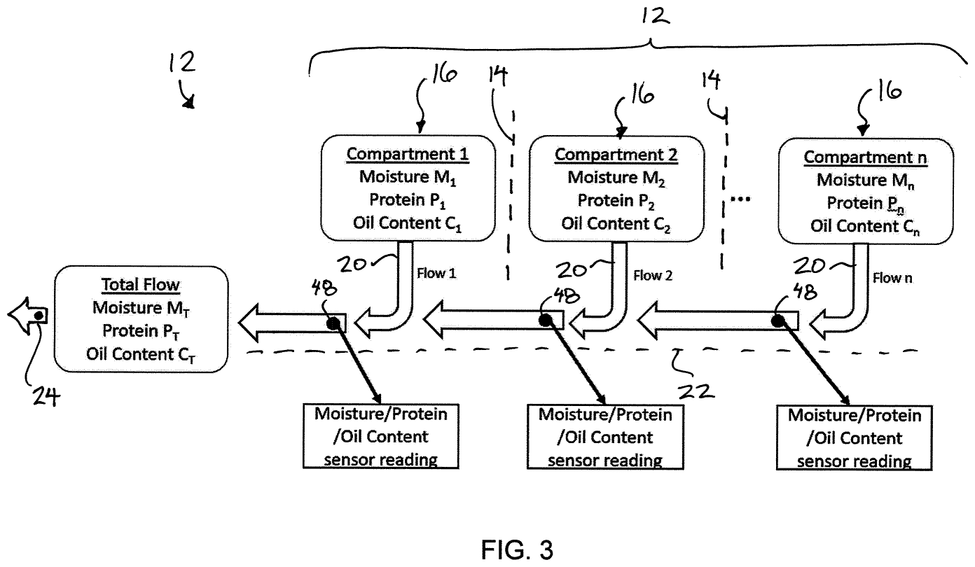

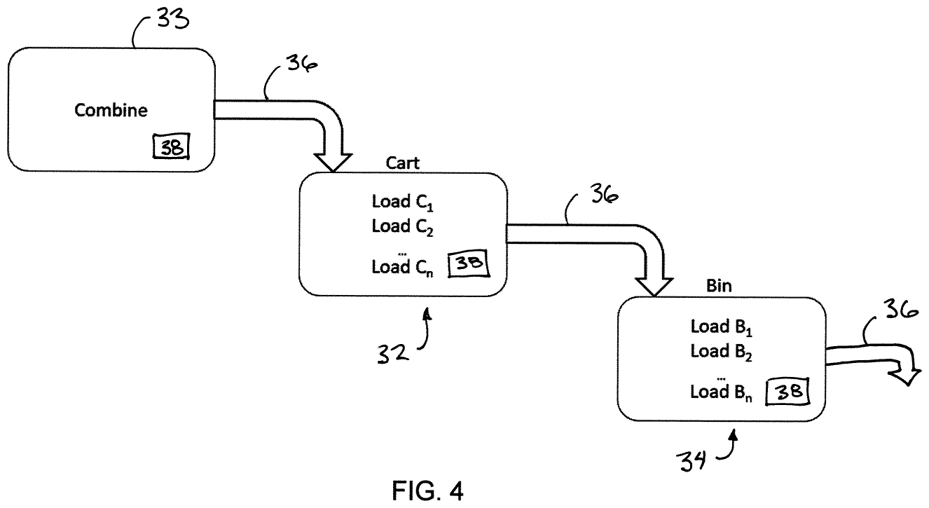

As shown in FIGS. 3 and 4, when the grain storage apparatus has multiple compartments or areas (either physically divided or not), each having an average moisture, protein, and oil content. By varying the relative flow rate from each area during an unload, a total unload moisture, protein, or oil content can be achieved, where one of these parameters can be set as a target. The average moisture, protein, and oil content in each compartment/area can be calculated using data tracking from combine unloads, sensors onboard intermediary grain handling equipment (grain cart(s)), and/or from sensors onboard the equipment being controlled.

The load data tracking may work as follows. Each load from the combine into the grain cart would have an associated weight, average moisture, protein, and/or oil content. The grain cart may contain multiple combine unloads. When the grain cart unloads, its unload would have an associated average moisture, protein, and/or oil content calculated as the weighted average of the loads it is carrying at the time. This logic can be extended, where a second grain transport apparatus 34 (for example a Motherbin) may contain multiple grain cart loads, and its unloads would have a new calculated average moisture, protein, and/or oil content. Not explicit in FIG. 4 is that the second grain transport apparatus 34 may have multiple compartments/areas as described above, in which case the compartment that the grain cart is unloading into would also need to be known and tracked.

Since various modifications can be made in the invention as herein above described, and many apparently widely different embodiments of same made, it is intended that all matter contained in the accompanying specification shall be interpreted as illustrative only and not in a limiting sense.

1. A grain mixing system comprising:
a grain storage apparatus arranged to receive grain to be stored therein;
a plurality of variable discharges operatively connected to the grain storage apparatus, in which each variable discharge is arranged to discharge the grain from an associated grain storage region of the grain storage apparatus at a respective variable discharge rate to a common outlet of the grain storage apparatus;
a controller operatively connected to the variable discharges, the controller including a processor and a memory storing (i) programming instructions, (ii) a target grain parameter representing a desired parameter value of the grain at the common outlet, and (iii) a regional grain parameter associated with each grain storage region in which the regional grain parameter is representative of a parameter value of the grain stored in that grain storage region;
wherein the processor of the controller is arranged to execute the programming instructions whereby the controller is arranged to control operation of the variable discharges so as to combine the grain from the different grain storage regions at the common outlet in controllably variable proportions to achieve the target grain parameter at the common outlet based at least in part on the regional grain parameters as inputs to the controller.

2. The system according to claim 1 wherein the target grain parameter and the regional grain parameters relate to at least one of moisture content, protein level, oil content, or density of the grain.

3. The system according to claim 1 wherein the controller stores more than one different parameter type for each of the target grain parameter and the regional grain parameter.

4. The system according to claim 3 wherein the controller is arranged to set which parameter type is selected as the target grain parameter in response to a user selection.

5. The system according to claim 1 wherein the grain storage regions comprise respective compartments of the grain storage apparatus which are separated from one another by at least one barrier.

6. The system according to claim 1 further comprising a load opening associated with each grain storage region of the grain storage apparatus such that the grain storage regions are arranged to be loaded with grain independently of one another.

7. The system according to claim 1 wherein the target grain parameter is programmably adjustable by the controller in response to a user input.

8. The system according to claim 1 further comprising an output parameter sensor arranged to measure an output grain parameter at the common outlet of the grain storage apparatus for communication to the controller.

9. The system according to claim 8 wherein the controller is arranged to controllably vary the discharge rate of each variable discharge in real time in response to deviation of the output grain parameter from the target grain parameter.

10. The system according to claim 1 further comprising at least one regional parameter sensor associated with each grain storage region, wherein the controller is arranged to acquire the regional grain parameters from the parameter sensors associated with the grain storage regions respectively.

11. The system according to claim 10 further comprising a plurality of regional parameter sensors associated with each grain storage region, wherein the controller is arranged to acquire a plurality of measured values relating to the regional grain parameter for each grain storage region.

12. The system according to claim 1 wherein the system is arranged for use with a grain transport apparatus for unloading grain from the grain transport apparatus into the grain storage apparatus, and wherein the system further comprises:
a communication device operatively connected to the controller, in which the communication device is arranged to communicate with the grain transport apparatus so as to acquire the regional grain parameters from the grain transport apparatus.

13. The system according to claim 1 wherein the regional grain parameter for each grain storage region comprises a parameter map of a plurality of different parameter values associated with the grain stored at respective different portions of the grain storage region.

14. The system according to claim 13 wherein each parameter value of each parameter map is derived from a respective grain load which has been loaded into the grain storage apparatus from a grain transport apparatus.

15. The system according to claim 14 wherein each parameter value derived from a respective grain load is an average value that is representative of a plurality of measured values associated with respective loading events of the grain transport apparatus.

16. The system according to claim 1 wherein the system is arranged for use with a grain transport apparatus for unloading grain from the grain transport apparatus into the grain storage apparatus, and wherein the controller is further arranged to:
determine an optimal region among the different grain storage regions to discharge the grain from the grain transport apparatus based at least in part on said at least one of the target grain parameter, the transported grain parameter, and the regional grain parameters; and
communicate the optimal region to an operator of the grain transport apparatus.

17. A control system for unloading grain from (i) a grain transport apparatus having transported grain therein with a transported grain parameter associated with the transported grain to (ii) a grain storage apparatus arranged to blend stored grain from different grain storage regions of the grain storage apparatus having respective regional grain parameters associated with the different grain storage regions to achieve a target grain parameter at a common outlet of the grain storage apparatus, the control system comprising:
a controller; and
a communication device operatively connected to the controller so as to be arranged to communicate at least one of the target grain parameter, the transported grain parameter, and the regional grain parameters to the controller;
the controller including a processor and a memory storing programming instructions arranged to be executed by the processor whereby the controller is arranged to:
(i) determine an optimal region among the different grain storage regions to discharge the grain from the grain transport apparatus based at least in part on said at least one of the target grain parameter, the transported grain parameter, and the regional grain parameters; and
(ii) communicate the optimal region to an operator of the grain transport apparatus.

18. The system according to claim 17 wherein the target grain parameter, the transported grain parameter, and the regional grain parameters relate to at least one of moisture content, protein level, oil content, or density of the grain.

19. A method of unloading grain from (i) a grain transport apparatus having transported grain therein with a transported grain parameter associated with the transported grain to (ii) a grain storage apparatus arranged to blend stored grain from different grain storage regions of the grain storage apparatus having respective regional grain parameters associated with the different grain storage regions to achieve a target grain parameter at a common outlet of the grain storage apparatus, the method comprising:
determining an optimal region among the different grain storage regions to discharge the grain from the grain transport apparatus based at least in part on at least one of the target grain parameter, the transported grain parameter, and the regional grain parameters; and
communicating the optimal region to an operator of the grain transport apparatus.

20. The method according to claim 19 including unloading the transported grain from the grain transport apparatus into the determined optimal region of the grain transport apparatus in response to a communication to the operator relating to the determined optimal region.
